(19) United States
(12) Patent Application Publication
(10) Pub. No.: US 2021/0201426 A1
(43) Pub. Date: Jul. 1, 2021

(54) CONTACT DATA UPLOADS

(71) Applicant: Hewlett-Packard Development Company, L.P., Spring, TX (US)

(72) Inventors: Krishna Prasad Muraleedharan Pillai, Corvallis, OR (US); Allen Owen Wright, Corvallis, OR (US); Evan Scheessele, Corvallis, OR (US)

(73) Assignee: Hewlett-Packard Development Company, L.P., Spring, TX (US)

(21) Appl. No.: 17/047,904

(22) PCT Filed: Sep. 19, 2018
(86) PCT No.: PCT/US2018/051736

§ 371 Date: Oct. 15, 2020

(51) Int. Cl. G06Q 50/00; G06Q 10/10

(52) U.S. Cl. CPC G06Q 50/01; G06Q 10/10

(57) ABSTRACT

Example implementations relate to a computing device comprising a processing resource and a memory resource to store instructions executable by the processing resource. In some examples, the processing resource can execute instructions to determine that an introduction has occurred between a first party and a second party based on discoverability preferences of the first party. Responsive to the introduction having occurred and based on the discoverability preferences, the processing resource can execute instructions to broadcast contact data related to the first party. Responsive to the introduction having occurred and based on the discoverability preferences, the processing resource can execute instructions to receive contact data related to the second party. After receiving the contact data related to the second data, the processing resource can execute instructions to upload the contact data related to the second party to a server for management.

### BACKGROUND

At conferences, exhibitions, and other interactions of all sizes and sorts, business cards are exchanged for networking, business development, and various other reasons. A business card is usually, not exclusively, a thin, paper card displaying printed contact information related to a first party that gives the business card to a second party. Business cards can also come in other styles and forms. The contact information can include details such as a name, a professional title, a phone number, a street address, an email address, etc.

### BRIEF DESCRIPTION OF THE DRAWINGS

FIG. 1 illustrates an example diagram of a computing system including a first card device, a second card device, a first computing device, and a second computing device interacting with each other and a network consistent with the disclosure.

FIG. 2 illustrates an example diagram of a first computing device broadcasting to and receiving from a second computing device consistent with the disclosure.

FIG. 3 illustrates an example diagram of a first card device transmitting a first set of information to and receiving a second set of information from a second card device consistent with the disclosure.

FIG. 4 illustrates an example diagram of an interaction between a first party and a second party as being tracked by a sensor that is communicatively coupled with a network consistent with the disclosure.

FIG. 5 illustrates an example flow diagram of a portable computing device consistent with the disclosure.

FIG. 6 illustrates an example flow diagram of a method consistent with the disclosure.

FIG. 7 illustrates an example non-transitory machine-readable medium consistent with the disclosure.

### DETAILED DESCRIPTION

A party can give business cards of its own and receive business cards from other parties when networking. At some point, the party can lose business cards and/or details concerning the business card. This can be especially problematic when an introduction that resulted in an exchange of the business cards was limited to the exchange of business cards. The loss of the business cards and/or details concerning the business cards can result in a prevention of follow up networking and can cause a loss to business development. As such, examples described herein relate to networking between two parties and an exchanging of contact information that occurs during the networking interaction, A party can be at least one of an individual, multiple individuals, and/or a legal entity.

As used herein, “interaction” and “introduction” are used interchangeably and are not intended as limiting of each other. As used herein, “contact information” and “contact data” are used interchangeably and are not intended as limiting of each other. Contact data can be included in a set of information provided from a first computing device to a second computing device. Contact data can include such things as a name, a professional position, an employer, a phone number, a street address, an email address, etc.

In some examples, when a first party interacts with a second party, a first set of information related to the first party can be transmitted from a first computing device associated with the first party to a second computing device associated with the second party. In addition, a second set of information related to the second party can be received by the first computing device associated with the first party.

In some examples, a first card device can transmit a first set of information to and receive a second set of information from a second card device. The first card device and the second card device can be within a particular physical range of each other. The first card device and the second card device can be computing devices.

In some examples, a sensor can track an interaction between a first party and a second party. The tracking can occur within a geographical location. The tracking can cause an identification of a first account associated with the first party and a second account associated with the second party. When allowed by discoverability preferences of the first party, a first set of information related to the first party can be provided as a contact to the second account associated with the second party. In addition, when allowed by discoverability preferences of the second party, a second set of information related to the second party can be provided as a contact to the first account associated with the first party.

Applicable to examples consistent with the disclosure, the sets of information can be transmitted and received if allowed by the discoverability preferences of the parties. For example, a party can select whether to broadcast (e.g., transmit) information. The party can also select whether to receive information. For example, a party can select what type of information to broadcast and/or receive. A party can select who to broadcast to and/or who to receive information from. A party can select what range of distance the broadcast is to cover and/or what range of distance to receive information from. A party can select a length of a particular period of time of an interaction before a broadcast of the first set of information takes places and/or before a receipt of a second set of information is allowed. Other factors which allow a party to modify similar details about broadcasting and/or receiving sets of information may be selected.

In brief, a party can alter the party's discoverability preferences. Who to provide information to, for example, can involve such options as: a broadcast to computing devices; a broadcast to a specific computing device; and no broadcast to any computing device. For example, a party can select to broadcast a party's discoverability preferences for a second party to be notified about via a second computing device associated with the second party. A party can also select to broadcast his or her geographical location through a portable computing device associated with the party. Furthermore, a party can select to receive a geographical location of a specific party, if the specific party has selected to have it be broadcast. The number of specific parties a party can broadcast to and/or receive sets of information from is not limited and can be singular or multiple. As used herein, provide, broadcast, and transmit are interchangeable and are not intended be limiting of each other.

A set of information can be stored on a network including at least one server. The set of information can be accessed through instructions on a memory resource being executed by a processing resource on a computing device. In other words, a computing device can execute machine-readable instructions (e.g., an application) that allow a party to store and access a set of information. The server or servers can be local and thus limited in accessibility or can be cloud based and accessible from anywhere via an internet connection. As such, a cloud server can be a local server and vice versa. The cloud server can be a singular cloud server used by both a first party and a second party or can be multiple cloud servers used separately by each party. The server, whether cloud or local, can manage the set of information, including storage, altering of a party's discoverability preferences, and similar capabilities.

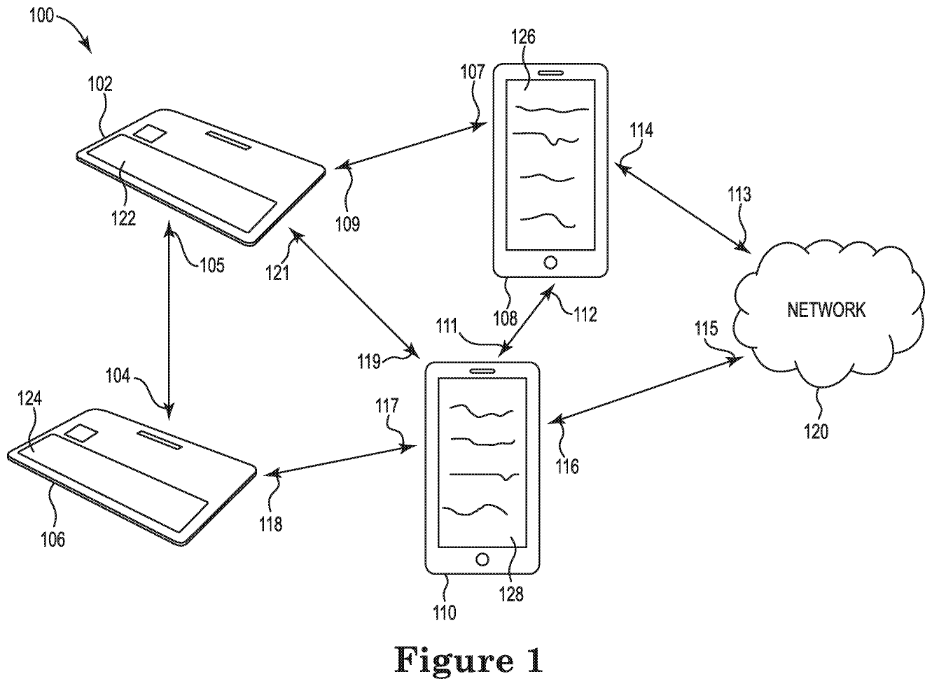

FIG. 1 illustrates an example diagram of a computing system 100 including a first card device 102, a second card device 106, a first computing device 108, and a second computing device 110 interacting with each other and a network 120 consistent with the disclosure. In the computing system 100, the first card device 102 provides 104 a first set of information 122 to and receives 105 a second set of information 124 from the second card device 106. The first card device 102 can also provide 119 the first set of information 122 to and receive 121 a second set of information 128 from the second computing device 110.

After having received the sets of information 122 and 124 from each other, the card devices 102 and 106 can separately upload 107 and 117 their respective sets of information 122 and 124 to the first computing device 108 and the second computing device 110, respectively. For example, after the second set of information 124 has been received 105 by the first card device 102, the first card device 102 can be communicatively coupled to the first computing device 108 comprising a processing resource and a memory resource. Instructions stored on the memory resource can be executable by the processing resource to collect the second set of information 124 from the first card device 102. The instructions can further be executed to upload the second set of information to a network 120. As used herein, uploading instructions and/or data to a network 120 can describe uploading the instructions and/or data to a computing device via the network 120. In one example, the network 120 includes a cloud server or a cloud computing system. For example, the instructions and/or data can be uploaded to a cloud computing system via the network 120. The communicative coupling of the first computing device 108 to the first card device 102 can occur through a physical connection, a wireless connection (e.g., Bluetooth connection and/or WiFi connection among others), and other means of communicatively coupling two devices. For example, the first computing device 108 can connect via Bluetooth to the first card device 102 to collect the second set of information 124 and upload it to a network 120.

The computing devices 108 and 110 can each separately be at least one of a stationary computing device and/or a portable computing device. Transmissions from 109, 111, and 118 and receipts by 107, 112, and 117 the first computing device 108 to either of the card devices 102 and 106 and/or the second computing device 110 can take place over a physical connection, a wireless connection (e.g., Bluetooth connection and/or WiFi connection among others), and other means of communicatively coupling two computing devices. The second sets of information 124 and 128 transmitted from the second card device 106 and/or the second computing device 110 can be received by the first card device 102 and/or the first computing devices 108 either before, after, or as the first set of information 122 and 126 is being transmitted. Whether a card device or a computing device is to provide (e.g., broadcast) and receive a set of information can be selected based on a party's discoverability preferences.

Once the computing devices 108 and 110 receive the sets of information 122, 124, 126, and 128 from other computing devices 108 and 110 and/or card devices 102 and 106, notes can be added to the sets of information 122, 124, 126, and 128 on the computing devices 108 and 110. Notes can be created before the sets of information 122, 124, 126, and 128 are received. Notes can also be added after the sets of information 122, 124, 126, and 128 are uploaded to the network 120. A note related to a set of information 122, 124, 126, and 128 can be in the form of at least one of an electronically typed message, an image, a video recording, and/or an audio recording, among other such means of adding details concerning an interaction. In addition to adding a note to the sets of information 122, 124, 126, and 128, the sets of information 122, 124, 126, and 128 can be edited before being uploaded to the network 120 or after the upload as occurred. Furthermore, the uploads 107 and 117 of the sets of information 122 and 124 to the computing devices 108 and 110 can include supplemental details (e.g., metadata concerning the sets of information 122 and 124).

Once uploaded 107 and 117 to the computing devices 108 and 110, each set of information 126 and 128 can be uploaded 113 and 115 to the network 120. Management of each set of information 126 and 128 on the network 120 can take place through a computing device with access to the network 120. For example, a party can manage the first set of information 122 and make edits to it after the upload 113 to the network 120. As used herein, management includes storing of a set of information, making edits to a set of information, and/or selecting discoverability of a set of information, among other similar capabilities.

In addition to the computing devices 108 and 110 uploading 113 and 115 the sets of information 126 and 128 to the network 120, the computing system 100 presents separate receipts 114 and 116 of the sets of information 126 and 128 from the network 120 by the computing devices 108 and 110. The receipts 114 and 116 are followed by a transmission 109 and 118 of the received sets of information (not shown) from the computing devices 108 and 110 to the card devices 102 and 106.

In some examples, a set of information related to the party and stored on a network 120 can be updated and subsequently transmitted to a computing device 108 and 110. The computing device 108 and 110 can provide the updated set of information to other computing devices 108 and 110 and/or card devices 102 and 106. In addition, the computing device 108 and 110 can also transmit the updated set of information to a card device 102 and 106 associated with the party. Subsequently, the card device 102 and 106 can provide the updated set of information to other card devices 102 and 106 and/or computing devices 108 and 110. A computing device 108 and 110 can be substituted for at least one of the network 120 and the card device 102 and 106. In some examples, an update can take place on the computing device 108 and 110 and transmitted to the card device 102 and 106 without involvement of the network 120. In some examples, the update can be sent from the network 120 to the computing device 108 and 110 without being transmitted to the card device 102 and 106.

Furthermore, the network 120 can make an update to a set of information while distant from an occurring interaction. Once the update is made to the set of information, the set of information can be transmitted to a computing device present at the interaction. For example, a member of a party can update a set of information at a location while an interaction occurs at a different location. The updated set of information can be transmitted from the network to a computing device at the different location during occurrence of the interaction. As such, a newly updated set of information can be broadcast at the interaction.

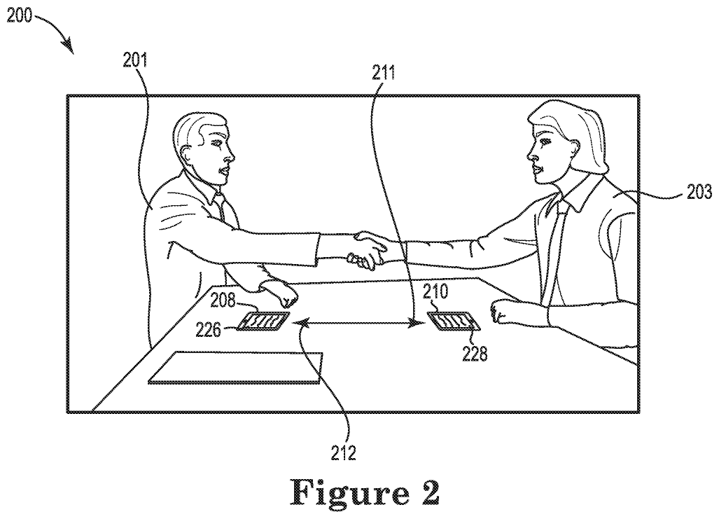

FIG. 2 illustrates an example diagram 200 of a first computing device 208 broadcasting 211 to and receiving 212 from a second computing device 210 consistent with the disclosure. In diagram 200, a computing device 208 can correspond to a first party 201 and a computing device 210 can correspond to a second party 203, The first and the second computing devices 208 and 210 are portable. The computing devices 208 and 210 can each include a processing resource and a memory resource (not shown). The memory resources of each of the computing devices 208 and 210 can store instructions executable by the processing resources to determine that an introduction has occurred between a first party 201 and a second party 203. The determination of an introduction occurring can be based on discoverability preferences of each party.

In response to the introduction having occurred and based on the discoverability preferences of the first party 201, the first computing device 208 broadcasts 211 contact data 226 related to the first party 201. When the second party 203 has set discoverability preferences of the second computing device 210 to accept broadcasts, the second computing device 210 receives the broadcast 211 of the contact data 226 related to the first party 201. When the second party 203 has set discoverability preferences of the second computing device 210 to broadcast contact data 228 related to the second party 203, the second computing device 210 broadcasts said contact data 228 related to the second party 203. In addition, when the first party 201 has set discoverability preferences of the first party 201 to receive contact data, the first computing device 208 receives the contact data 228 related to the second party 203 when it is broadcast.

In FIG. 2, the transmitting and receipt of contact data is wireless and can be through Bluetooth, NFC, and/or other such means of wireless communicative coupling of two computing devices 202 and 208. The communicative coupling can also include a physical connection between the two computing devices 208 and 210,

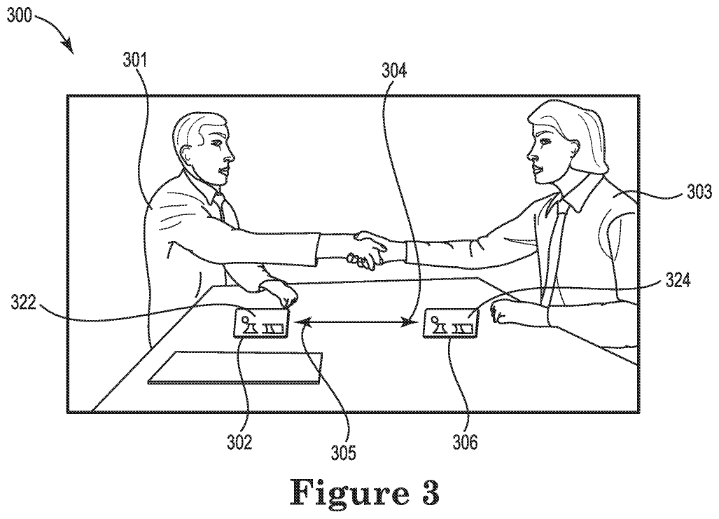

FIG. 3 illustrates an example diagram 300 of a first card device 302 transmitting 304 a first set of information 322 to and receiving 305 a second set of information 324 from a second card device 306 consistent with the disclosure. In the example of FIG. 3, the first card device 302 is resting besides a first party 301 and the second card device 306 is resting besides a second party 303. In the example of FIG. 3, the first card device 302 and the second card device 306 are within a particular physical range of each other. In FIG. 3, the first card device 302 and the second card device 306 are left alone, seemingly at rest besides a first party 301, associated with the first card device 302, and a second party 303, associated with the second card device 306. As the parties converse with each other in the particular range, for example, the card devices 302 and 306 become active.

The activation of the first card device 302 is reflected by the first card device 302 transmitting 304 a first set of information 322 to the second card device 306. In addition, the first card device 302 receives 305 a second set of information 324 from the second card device 306. The exchange of the first 322 and the second 324 sets of information is based on discoverability preferences, as set separately by the first 301 and the second 303 parties. Alternatively, or in addition, activation of the card devices 302 and 306 can include broadcasting the parties' discoverability preferences. The discoverability preferences can vary and are dependent upon the party who selects them. For example, the broadcast discoverability preference of the first party 301 can include one of: a broadcast to computing devices: a broadcast to a specific computing device; and no broadcast to any computing device. The same can be true of the second party 303.

As stated above, the discoverability preferences can be altered to set such things as the area covered by the particular physical range for the card devices 302 and 306 to be activated, as well as details about what sets of information to be broadcast and receive are include. The broadcast 304 and receipt 305 (e.g., the communicative coupling of the first card device 302 to the second card device 306) can be performed through a variety of means that can be based on an individual or multiple factors, including a particular physical range. For example, the communicative coupling of the first card device 302 to the second card device 306 can occur based on a near field communication module. The communicative coupling of the first card device 302 to the second card device 306 can occur based on an infrared module. The communicative coupling of the first card device 302 to the second card device 306 can occur based on an optical scanning of a two-dimensional bar-code. The communicative coupling of the first card device 302 to the second card device 306 can occur based on a reading of a magnetic strip. Alternatively, or in addition, other means of communicative coupling card devices can be utilized.

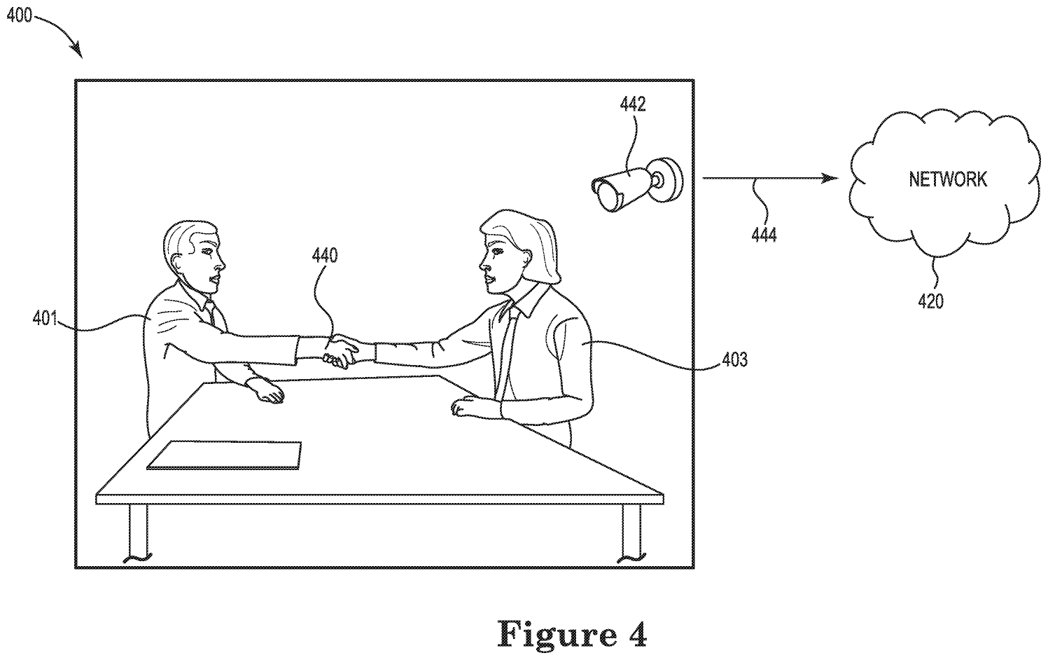

FIG. 4 illustrates an example diagram 400 of an interaction 440 between a first party 401 and a second party 403 as being tracked by a sensor 442 that is communicatively coupled 444 with a network 420 consistent with the disclosure. In the non-limiting example of FIG. 4, a sensor 442 (e.g., a camera in FIG. 4) tracks gestures made by parties within a geographical location (e.g., area covered by the camera), When a first party 401 and a second party 403 perform an interaction 440 through a gesture (e.g., handshake), the camera identifies a first account associated with the first party 401 and a second account associated with the second party 403. The first account and the second account are stored on the network 420 and include discoverability preferences. In the example of FIG. 4, the sensor 442 is a computer-enhanced camera with capabilities including communicatively coupling to the network and accessing the accounts. Alternatively, or in addition, the sensor can communicatively couple with a card device (e.g., the card device 102 and 106 in FIGS. 1 and 302 and 306 in FIG. 3) and/or a computing device (e.g., the computing device 108 and 110 in FIGS. 1 and 208 and 210 in FIG. 1) to access the accounts on the network.

When the discoverability preferences of both parties allow, a first set of information related to the first party 401 is provided as a contact to the second account associated with the second party 403. Additionally, when the discoverability preferences of both parties allow, a second set of information related to the second party 403 is provided as a contact to the first account associated with the first party 401. In other words, when the first account has the discoverability preferences set to provide a first set of information and receive a second set of information, the first account can do both provide and receive. If, for example, the first account has discoverability preferences set to receive and not provide, the first account would receive the second set of information as a contact and not provide the first set of information.

The preferences of each party determine what is provided and what is received. For example, the first party can select to have a geographical location of the first party provided to the second party via a second computing device associated with the second party. The second party can select to have a geographical location of the second party provided to the first party through a first computing device associated with the first party.

In the example of FIG. 4, the sensor is a computer-enhanced camera 442. Alternatively, or in addition, the sensor can also comprise at least one of a microphone, a scanner, and/or other types of sensors. Each of these can be further enhanced by computerized technology to better track and identify actions associated with a party. The tracking can further comprise capturing, by the sensor, at least one of a gesture made by a party, a voice command made by a party, a particular marking on a party, and/or a device corresponding to the party. For example, as stated above, the camera can be equipped with computer-enhanced vision to recognize a party and then track and identify a handshake of the party. The microphone can be equipped with computer-enhanced voice recognition to recognize a first party and a second party by voice and then track and identify the first party saying, “I want his contact data” about the second party. The particular marking on a party can include computer-enhanced wearables that communicate preferences related to discoverability and interest in providing as well as receiving contact data. The device corresponding to the party can include at least one of a card device (e.g., 102 and 106 in FIGS. 1 and 302 and 306 in FIG. 3), a computing device (e.g., 108 and 110 in FIGS. 1 and 308 and 310 in FIG. 3), or another trackable and/or identifiable device. Overall, as is to be understood by those skilled in the art, there are multiple ways to supplement the tracking and identifying capabilities of sensors.

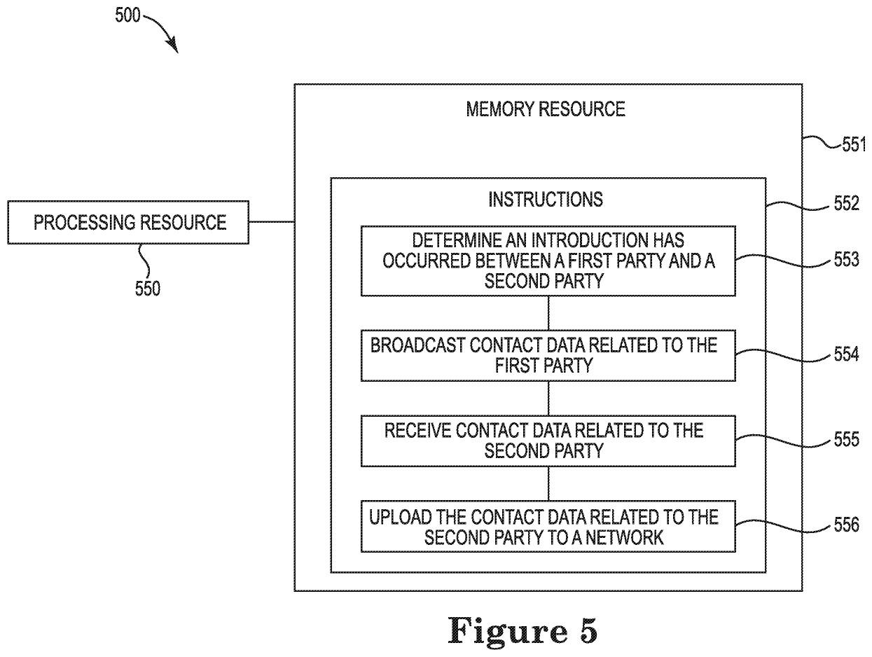

FIG. 5 illustrates an example flow diagram of a portable computing device consistent with the disclosure. As shown in FIG. 5, the portable computing device 500 includes a processing resource 550 and a memory resource 551.

The processing resource 550 may be a hardware processing unit such as a microprocessor, application specific instruction set processor, coprocessor, network processor, or similar hardware circuitry that can cause machine-readable instructions to be executed. In some examples, the processing resource 550 may be a plurality of hardware processing units that can cause machine-readable instructions to be executed. The processing resource 550 can include central processing units (CPUs) and/or graphics processing units (GPUs), among other types of processing units. The memory resource 551 may be any type of volatile or non-volatile memory or storage, such as random access memory (RAM), flash memory, read-only memory (ROM), storage volumes, a hard disk, or a combination thereof.

The memory resource 551 may store instructions 552 thereon. When executed by the processing resource 550, the instructions 552 may cause the portable computing device 500 to perform specific tasks and/or functions. For example, at block 553, the memory resource 551 may store instructions 552 which may be executed by the processing resource 550 to cause the portable computing device 500 to determine that an introduction has occurred between a first party and a second party based on discoverability preferences of the first party. At block 554, the memory resource 551 may store instructions 552 which may be executed by the processing resource 550 to cause the portable computing device 500 to broadcast contact data related to the first party in response to the introduction having occurred and based on the discoverability preferences. At block 555, the memory resource 551 may store instructions 552 which may be executed by the processing resource 550 to cause the portable computing device 500 to receive contact data related to the second party in response to the introduction having occurred and based on the discoverability preferences. At block 556, the memory resource 551 may store instructions 552 which may be executed by the processing resource 550 to cause the portable computing device 500 to upload the contact data related to the second party to a network for management.

In some examples, the discoverability preferences can include an option to limit discoverability of the portable computing device. The discoverability preferences can be altered (e.g., modified) to match the needs of a user. For example, a user may prefer not to be discover at a first time and to be discovered at a second time and can alter his discoverability preferences as the preferences may vary over time.

In some examples, the contact data related to the second party can be edited in advance of the upload of the contact data related to the second party to the network. In some examples, the contact data related to the second party can be edited subsequent to the upload of the contact data related to the second party to the network. Contact data edited subsequent to the upload of the contact data can be reuploaded to the network.

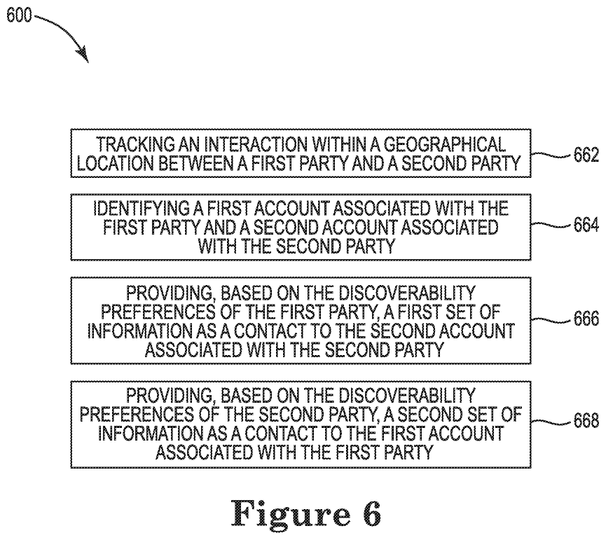

FIG. 6 illustrates an example flow diagram of a method 600 consistent with the disclosure. At block 662, the method can include tracking an interaction (shown as 440 in FIG. 4) within a geographical location between a first party (e.g., the first party 201 in FIG. 2, 301 in FIG. 3, and 401 in FIG. 4) and a second party (e.g., the second party 203 in FIG. 2, 303 in FIG. 3, and 403 in FIG. 4). In some examples, the tracking can be performed by a sensor that can include at least one of a camera (e.g., the camera 442 in FIG. 4), a microphone, a scanner, and/or other types of sensors. In some examples, the interaction can be in the form a gesture (handshake in FIG. 4), a voice command, a particular marking, or another such way of trackable communication. In some examples, the geographical location can be determined by how much a sensor (or multiple communicatively coupled sensors) can cover. For example, the camera can be communicatively coupled to other cameras and thereby cover multiple rooms thus allowing for tracking of an interaction that takes multiple rooms to complete (e.g., a wave by a first party in one room and a reply wave by a second party in another room).

At block 664, the method can include identifying a first account associated with the first party and a second account associated with the second party. In some examples, the first account and the second account are stored on a network. In addition, the identifying of the first account and the second account are based on discoverability preferences of the first party and the second party respectively.

At block 666, the method can include providing, based on the discoverability preferences of the first party, a first set of information as a contact to the second account associated with the second party. The providing of the first set of information can be performed by and on the network.

At block 668, the method can include providing, based on the discoverability preferences of the second party, a second set of information as a contact to the first account associated with the first party. The providing of the second set of information can also be performed by and on the network.

In some examples, the method 600 can include providing, based on respective discoverability preferences, a geographical location of the second party to the first party via a first portable computing device and a geographical location of the first party to the second party via a second portable computing device.

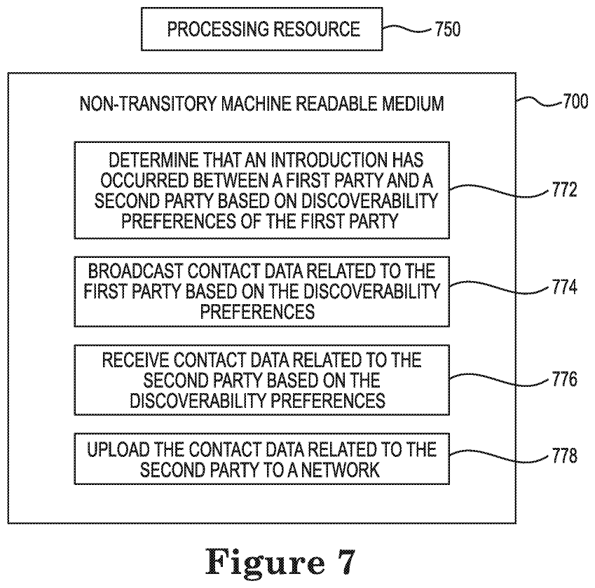

FIG. 7 illustrates an example non-transitory machine-readable medium 700 consistent with the disclosure. A processing resource 750 can execute instructions stored on the non-transitory machine-readable medium 700. The processing resource 750 can be a hardware processing unit such as a microprocessor, application specific instruction set processor, coprocessor, network processor, or similar hardware circuitry that can cause machine-readable instructions to be executed. In some examples, the processing resource 750 can be a plurality of hardware processing units that can cause machine-readable instructions to be executed. The processing resource 750 can include central processor units (CPUs) and/or graphics processing units (GPUs), among other types of processing units. The non-transitory machine-readable medium 700 can be any type of volatile or non-volatile memory or storage, such as random-access memory (RAM), flash memory, read-only memory (ROM), storage volumes, a hard disk, or a combination thereof.

The example medium 700 stores instructions 772 executable by the processing resource 750 to determine that an introduction (e.g., interaction 440 in FIG. 4) has occurred between a first party (e.g., the first party 201 in FIG. 2, 301 in FIG. 3, and 401 in FIG. 4) and a second party (e.g., the second party 203 in FIG. 2, 303 in FIG. 3, and 403 in FIG. 4) based on discoverability preferences of the first party. In some examples, the discoverability preferences can include an option to limit discoverability of a portable computing device including the non-transitory machine-readable medium and processing resource. In some examples, the instructions are further to alter the discoverability preferences.

The example medium 700 stores instructions 774 executable by the processing resource 750 to broadcast contact data related to the first party in response to the introduction having occurred and based on the discoverability preferences. The example medium 700 stores instructions 776 executable by the processing resource 750 to receive contact data related to the second party in response to the introduction having occurred and based on the discoverability preferences. The example medium 700 stores instructions 778 executable by the processing resource 750 to upload the contact data related to the second party to a network for management.

The above stated examples are non-limiting and are not strictly subject to performance in the order presented in the examples. For example, a sensor can recognize an account in advance of tracking an interaction. As such, underlying points presented by the examples can be performed in various other ways, including either at a greater expanse or a further limitation relative to the examples.

In the foregoing detailed description of the disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the disclosure.

What is claimed:

1. A computing device comprising:
a processing resource; and
a memory resource to store instructions executable by the processing resource to:
determine that an introduction has occurred between a first party and a second party based on discoverability preferences of the first party;
broadcast contact data related to the first party in response to the introduction having occurred and based on the discoverability preferences;
receive contact data related to the second party in response to the introduction having occurred and based on the discoverability preferences; and
upload the contact data related to the second party to a server for management.

2. The computing device of claim 1, wherein the discoverability preferences include an option to limit discoverability of the portable computing device.

3. The computing device of claim 1, wherein the instructions are further to alter the discoverability preferences.

4. The computing device of claim 1, wherein the instructions are further to edit the contact data related to the second party in advance of the upload of the contact data related to the second party.

5. A computing system comprising:
a first card device to:
transmit a first set of information to a second card device;
receive a second set of information from the second card device, wherein the first set of information and the second set of information include contact information exchanged during an interaction; and
a computing device comprising a processing resource and a memory resource to:
collect the second set of information from the first card device; and
upload the second set of information received from the first card device to a cloud server for management.

6. The computing system of claim 5, wherein a transmission of the first set of information from the first card device and a receipt of the second set of information by the first card device occurs through at least one of a near field communication module, an infrared module, an optical scanning of a two-dimensional bar-code, and a reading of a magnetic strip.

7. The computing system of claim 5, wherein a collection of the second set of information by the computing device occurs through at least one of a Bluetooth connection and a physical connection.

8. The computing system of claim 5, wherein the cloud server manages discoverability preferences of the card device to enable a transmission of the first set of information and a receipt of the second set of information.

9. The computing system of claim 8, wherein, based on the discoverability preferences, the first card device is further to broadcast a discoverability preference.

10. The computing system of claim 8, wherein the discoverability preferences of the card device include one of:
a broadcast to computing devices;
a broadcast to a specific computing device; and
no broadcast to any computing device.

11. The computing system of claim 5, wherein the upload of the second set of information further includes an audio recording related to the interaction.

12. A method comprising:
tracking an interaction within a geographical location between a first party and a second party;
identifying a first account associated with the first party and a second account associated with the second party, wherein the first and second accounts are stored on a cloud server and include discoverability preferences of the first and second parties;
providing, by the cloud server and based on the discoverability preferences of the first party, a first set of information as a contact to the second account associated with the second party; and
providing, by the cloud server and based on the discoverability preferences of the second party, a second set of information as a contact to the first account associated with the first party.

13. The method of claim 12, wherein the tracking further comprises capturing, by a sensor, at least one of a gesture made by a party, a voice command made by the party, and a particular marking on the party.

14. The method of claim 13, wherein the sensor comprises at least one of a camera, a microphone, and a scanner.

15. The method of claim 12, further comprising providing, based on respective discoverability preferences, a geographical location of the second party to the first party via a first portable computing device and a geographical location of the first party to the second party via a second portable computing device.
